(19) United States
(12) Patent Application Publication
(10) Pub. No.: US 2008/0192753 A1
(43) Pub. Date: Aug. 14, 2008

(54) METHOD AND SYSTEM FOR PROVIDING QoS SERVICE

(75) Inventor: Hejun LI, Shenzhen (CN)

Correspondence Address: Leydig, Voit & Mayer, Ltd;(for Huawei Technologies Co., Ltd), Two Prudential Plaza Suite 4900, 180 North Stetson Avenue, Chicago, IL, 60601, US

(73) Assignee: HUAWEI TECHNOLOGIES CO., LTD., Shenzhen (CN)

(21) Appl. No.: 12/099,303

(22) Filed: Apr. 8, 2008

Related U.S. Application Data
(63) Continuation of application No. PCT/CN2007/000553, filed on Feb. 15, 2007.

(30) Foreign Application Priority Data
Feb. 21, 2006 (CN) 200610033907.3

(51) Int. Cl. H04L 12/56

(52) U.S. Cl. 370/395.21

(57) ABSTRACT

A method and system for providing QoS service includes analyzing signaling packets by which various soft terminals/hardware terminals register to a system and call the system, extracting the user signaling feature codes, such as the telephone number or domain name of the user and the audio, video and data information, from the signaling packet, and analyzing whether the system has been configured with the QoS information corresponding the signaling feature codes. If the matched configuration information of the user is found, the method and system perform bandwidth limitation and bandwidth guarantee according to the QoS information. In this way, the bandwidths of users do not interfere with each other, and the call quality of users are guaranteed.

This application is a continuation of International Patent Application No. PCT/CN2007/000553, filed on Feb. 15, 2007, claiming priority to Chinese Patent Application No. 200610033907.3 submitted with the State Intellectual Property Office of P.R.C. on Feb. 21, 2006, entitled “A Method and System for Providing QoS Service,” both the content of which are incorporated herein by reference in their entirety.

### FIELD OF THE INVENTION

The invention relates to the technical field of network communications, and in particular, to a method and system for providing Quality of Service (QoS) service.

### BACKGROUND OF THE INVENTION

With the development of communication technologies, the Next Generation Network (NGN) and Internet Protocol Multimedia Subsystem (IMS) have found broad application. One major trend is to carry services, such as voice, image, video and data over Internet Protocol (IP) networks, whereupon there emerge a number of protocols supporting the multimedia applications over IP networks. These protocols, together with other protocols, are utilized to constitute a complete multimedia communication system. With the gradual exuberance of real-time multimedia services, ensuring the bandwidth of legal users while limiting the bandwidth of illegal users is becoming very important.

In existing techniques, in order to provide QoS services, a conventional stream classification method is generally employed to identify different data streams so as to process the data streams differently.

In the stream classification method, the Access Control List (ACL) classification rules are configured, packets are classified according to the classification rules and identified according to the result of the classification, and then provided to the subsequent QoS mechanism, such as Committed Access Rate (CAR), congestion management, bandwidth guarantee and the like. This method is suitable to uniformly limit the bandwidth of IP packets in compliance with the configured rules.

In a simple stream classification, a packet is typically classified according to the Type of Service (TOS) field domain in the IP packet header. With the application of DifferServ model, the ToS domain of IP is redefined as Differentiated Service (DS) domain, which is referred to as DS Code Pointer (DSCP) domain.

In a complicated stream classification, a packet is classified according to a number of properties of the packet, typically five (5) feature domains of the IP packet itself, i.e. IP destination address, IP source address, protocol type of the payload carried in IP packet, destination port of Transfer Control Protocol (TCP) or User Datagram Protocol (UDP), and source port of TCP or UDP. There also exists a stream classification method employing sextet, in which a DSCP domain is added on the basis of the above described quintuple.

FIG. 1 shows a QoS system based on stream classification. The system is divided into a control layer and a forwarding layer. The control layer includes a network management station or control station 111, and a stream classification rules management module 112. The forwarding layer includes a look-up module 121, a CAR module 122, a DSCP remark module 123, and a bandwidth guarantee module 124.

FIG. 2 shows the operation flow of the QoS system based on stream classification, which includes:

Block 210:

A user configures stream classification rules and QoS parameter information corresponding to the stream classification rules via the network management station or control station. The stream classification rules management module of the control layer receives and processes the information, and delivers the stream classification rules and QoS parameter information corresponding to the stream classification rules to the forwarding layer.

Block 220:

The forwarding layer receives a packet, searches for stream classification rules corresponding to the packet, and performs bandwidth limitation and DSCP remark after the matched configured rules have been found.

Block 230:

A corresponding bandwidth guarantee is performed according to the result of the DSCP remark.

In known systems, it is impossible to configure ACL classification rules for each user respectively, accordingly it is impossible to perform differentiated bandwidth limitation and bandwidth guarantee for different users. This is because a user is determined uniquely by an IP address and a TCP or UDP source port in an IP network. The number of the source port is assigned to the user each time the user initiates a call or each time the user responds to a call. In other words, the number of the source port can not be known in advance. Therefore, it is impossible to configure ACL classification rules for each user respectively. In addition, there may be a number of users that are in compliance with the same ACL stream classification rules, and in the above described solution the bandwidth of all the users that are in compliance with the ACL stream classification rule is limited uniformly. Accordingly, the bandwidth of a certain user may be occupied by another user.

In known systems, it is impossible to limit the bandwidth of different services for users. As shown in FIG. 3, the audio, video and data of a user exist in the signaling Session Description Protocol (SDP) information over the transport layer 310 of an IP packet, as the feature code fields of the signaling packet. The existing stream classification method can match only up to the transport layer 310 at most, and thus can not identify the different features of users. In addition, it is impossible to respectively limit the bandwidth of different services, such as the audio, video and data of a user and the like.

### SUMMARY OF THE INVENTION

Embodiments of the invention provide a method and system for providing Quality of Service (QoS) service, which may perform QoS guarantee for different users as well as different types of services of a same user, so as to achieve the intelligent control of user traffics.

According to an embodiment of the invention, a method for providing QoS service includes:

when receiving a signaling packet of a user or a resource reservation signaling packet delivered by a policy server, constructing user service QoS configuration information at a forwarding layer based on signaling feature codes of the signaling packet; when receiving a service packet of the user, querying the user service QoS configuration information based on service information of the service packet; performing bandwidth guarantee for the service packet according to a query result.

According to another embodiment of the invention, a system for providing QoS service may be divided into a control layer and a forwarding layer. The system includes:

a user media and QoS information management module, located at the control layer, adapted for searching for QoS information matched with signaling feature codes of a signaling packet of a user, and constructing user service QoS configuration information at the forwarding layer according to the signaling feature codes; a user bandwidth limitation and priority remark module, located at the forwarding layer, adapted for querying the user service QoS configuration information according to service information of a service packet of the user, and processing the service packet according to a querying result; and a user bandwidth guarantee module, located at the forwarding layer, adapted for perform bandwidth guarantee according to the processing by the user bandwidth limitation and priority remark module to the service packet.

According to the embodiments of the invention, a signaling sorting method is employed to analyze various signaling packets, extract the signaling feature codes in the signaling packets, and perform bandwidth limitation and bandwidth guarantee for service packets according to the QoS information corresponding to the signaling feature codes. In this way, the bandwidth of users may not interfere with each other; the system may guarantee different bandwidth for different types of services of the users, so as to achieve the intelligent control of the user traffics.

### BRIEF DESCRIPTION OF THE DRAWINGS

FIG. 1 is a schematic diagram showing a QoS system based on stream classification;

FIG. 2 is a flow chart showing a process of providing QoS service based on stream classification;

FIG. 3 is a schematic diagram showing a signaling packet;

FIG. 4 is a schematic diagram showing a QoS system based on signaling feature codes according to an embodiment of the invention;

FIG. 5 is a flow chart showing a method for providing QoS service according to an embodiment of the invention.

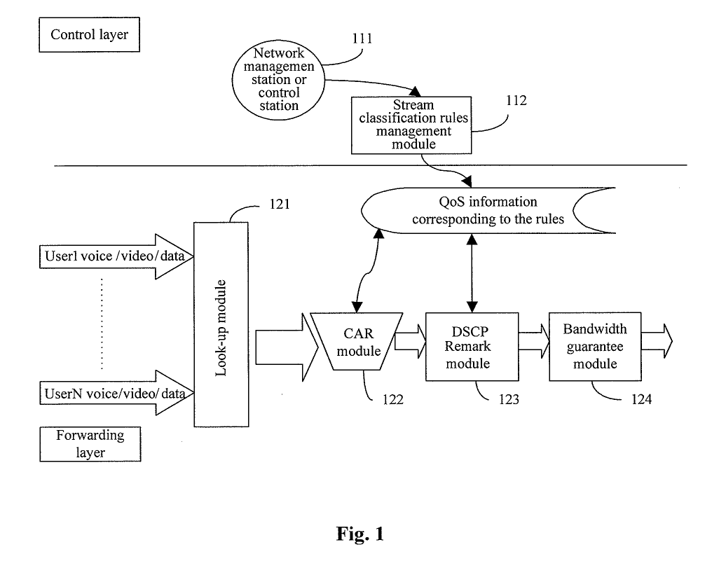

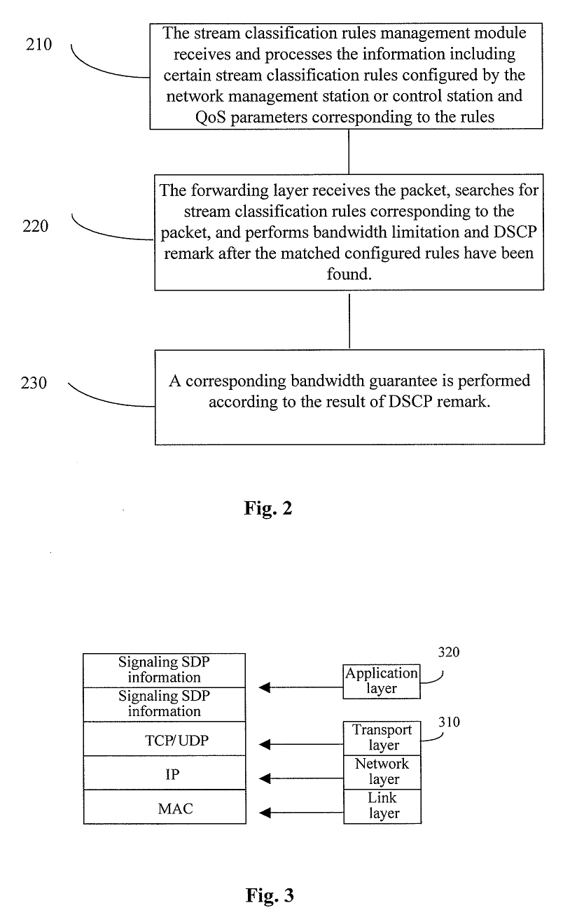

### DETAILED DESCRIPTION OF THE EMBODIMENTS

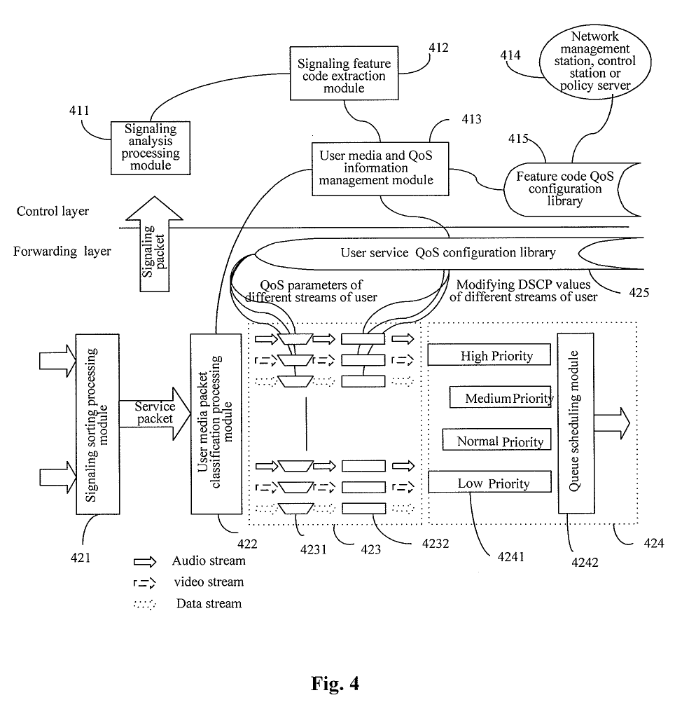

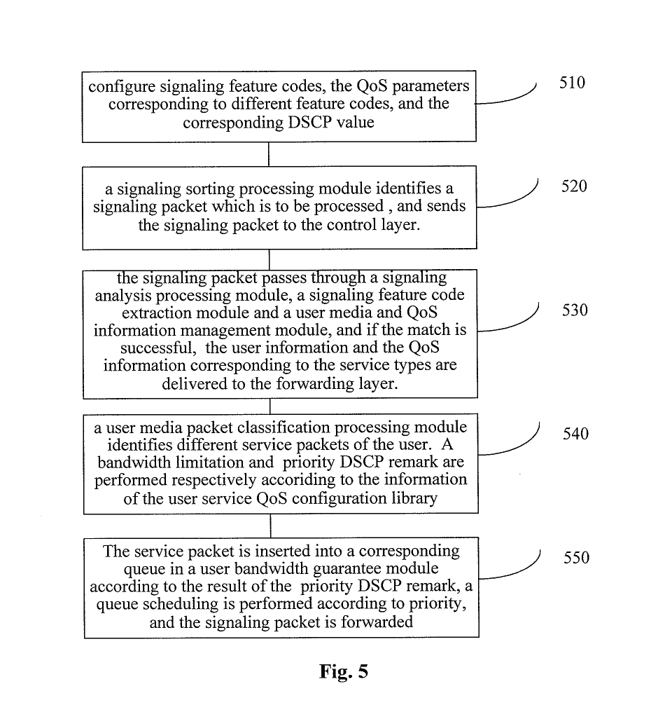

Referring to FIG. 4, a system for providing QoS service according to an embodiment of the invention is divided into a control layer and a forwarding layer. The control layer includes a signaling analysis processing module 411, a signaling feature code extraction module 412, a user media and QoS information management module 413, a network management station, control station or policy server 414 and a feature code QoS configuration library 415. The forwarding layer includes a signaling sorting processing module 421, a user media packet classification processing module 422, a user bandwidth limitation and priority remark module 423, a user bandwidth guarantee module 424, and a user service QoS configuration library 425.

The network management station, control station or policy server 414 is adapted to configure signaling feature codes, the QoS parameters corresponding to the different signaling feature codes, and the corresponding DSCP value, and store the signaling feature codes, the QoS parameters and the corresponding DSCP value into the feature code QoS configuration library 415. In other words, the QoS information, including QoS parameters and priority DSCP value, etc., is configured by the network management station, control station or policy server 414.

The QoS parameters include time delay, bandwidth or resource reservation, etc. The signaling feature codes include user identification, and service type identifications, etc. The user identification may be a telephone number or domain name of a user, and the service type identification may indicate the type of audio, video, and data, etc.

The signaling sorting processing module 421 is adapted to sort various signaling packets from user terminals and send the sorted signaling packets to the control layer. The signaling packets may be a signaling packet by which a soft terminal/hardware terminal registers to a system or calls the system, or may be a resource reservation signaling packet of a service policy server.

The signaling analysis processing module 411 and the signaling feature code extraction module 412 are adapted to analyze a signaling packet from the forwarding layer so as to obtain the signaling feature codes of the signaling packet.

The user media and QoS information management module 413 is adapted to query the feature code QoS configuration library 415 so as to obtain the QoS information matched with the signaling feature codes of the signaling packet, and deliver the user information and the QoS information corresponding to the signaling feature codes to the forwarding layer.

The user information and the QoS information corresponding to the signaling feature codes is stored in the user service QoS configuration library 425. In particular, the user service QoS configuration library 425 may contain the user information, the service type information and the QoS information corresponding to the service types of users.

The user media packet classification processing module 422 is adapted to classify the service packets from a user, and to identify different service packets of the user.

The user bandwidth limitation and priority remark module 423 is adapted to query the user service QoS configuration library 425 according to the service type information corresponding to the service packets, and perform bandwidth limitation and priority DSCP remark, respectively.

In a particular implementation, the user bandwidth limitation and priority remark module 423 includes a bandwidth limitation module 4231 adapted to limit bandwidth according to the QoS information corresponding to the service type contained in user service QoS configuration information, and a priority DSCP remark module 4232 adapted to perform priority DSCP remark according to the QoS information corresponding to the service type contained in the user service Qos configuration information.

The user bandwidth guarantee module 424 is adapted to insert the service packet into a corresponding queue according to the result of DSCP priority remark, perform a queue scheduling according to priority and output the service packet.

In a particular implementation, the user bandwidth guarantee module 424 contains a plurality of queues 4241 with different priorities adapted to accommodate service packets with different priority remarks. The user bandwidth guarantee module 424 may further include a queue scheduling module 4242 adapted to perform queue scheduling according to the priorities.

FIG. 5 is a flow chart showing a method for providing QoS service according to an embodiment of the invention.

Block 510: A network management station, control station or policy server configures signaling feature codes, the QoS parameters (e.g. the Qos parameters such as a bandwidth of 64 Kbps guaranteed for audio, a bandwidth of 2 Mbps guaranteed for video) corresponding to the different signaling feature codes, and the corresponding DSCP value, and stores the signaling feature codes, the QoS parameters and the corresponding DSCP value into a feature code QoS configuration library.

The QoS information, including the QoS parameters such as bandwidth and time delay and the priority remark DSCP value and the like, is configured by the network management station, control station or policy server.

In a particular implementation, the signaling feature code may be extracted from signaling protocol.

The signaling protocol refers to the application layer protocols for establishing, changing or terminating a multimedia session, for example, the Session Initiation Protocol (SIP), H.248, the Media Gateway Control Protocol (MGCP), etc. The signaling protocol employs text code, and supports the multimedia communication functions such as audio, video, instant message and game.

For example, in Session Initiation Protocol (SIP), some important signaling feature code fields may be extracted from the signaling protocol, as shown in Table 1.

TABLE 1

| Signaling | |
|---|---|
| feature code | Explanation |
| Call-ID | Identification of a call |
| From | logical calling entity |
| To | Logical called entity (used with From, Call-ID for call |
| | match) |
| Contact | Real physical address, for routing |
| Via | Where a call passes through, used as the route of a |
| | response |
| Route | Route information of a call |
| Cseq | Sequence number of a call |
| Content-Length | Length of a message body |
| Content-Type | Type of a message body |
| Record-Route | Route which a call passes through (Route indicates the |
| | route of a call, and Record-Route is used for |
| | constructing a route) |

Block 520: A signaling sorting processing module of the forwarding layer identifies a signaling packet which is to be processed and is configured by the network management station, control station or policy server, and sends the signaling packet to the control layer.

Block 530: The signaling packet passes through a signaling analysis processing module and a signaling feature code extraction module of the control layer in order, and the signaling feature codes of the signaling packet are obtained. Then, a user media and QoS information management module queries the information in a feature code QoS configuration library according to the signaling feature codes obtained from the signaling packet to obtain the QoS information matched with the signaling feature codes. If the QoS information matched with the signaling feature codes is found, the user media and QoS information management module delivers the user information and the QoS information corresponding to the signaling feature codes to the forwarding layer.

Block 540: A user media packet classification processing module in the forwarding layer classifies service packets from the user, identifies the different service packets (such as, audio, video, and data packets) of the user. A user bandwidth limitation and priority remark module 423 queries a user service QoS configuration library according to the service type information corresponding to the service packets, and perform bandwidth limitation and DSCP priority remark and the like, respectively.

Block 550:

The service packets are inserted into a corresponding queue in a user bandwidth guarantee module according to the result of the DSCP priority remark. The principle for queuing is that, a user of higher priority enters into a queue of higher priority, while a user of lower priority enters into a queue of lower priority.

Then a queue scheduling is performed according to priority, and the service packets are forwarded.

According to some embodiments of the invention, a signaling sorting method is employed, to analyze signaling packets by which various soft terminals/hardware terminals register to a system and call the system, extract the signaling feature codes, such as the user information and the service type information, etc., from the signaling packet, and analyze whether the system has been configured with the QoS information corresponding to the signaling feature codes, and if the matched configuration information of the user is found, perform bandwidth limitation and bandwidth guarantee for service packets of different types of the user according to the QoS information. In this way, the bandwidth of different users will not interfere with each other, different types of services, such as audio, video and data, may be guaranteed with different bandwidth and different DSCP priority remarks. Thus, intelligent control for user traffic may be achieved.

In addition, in some embodiments of the invention, when receiving a call termination signaling packet of a user, the control layer deletes the information of the user in the forwarding layer. In a particular implementation, after the signaling analysis processing module 411 and the signaling feature code extraction module 412 extract the signaling feature codes of the call termination signaling packet, the user media and QoS information management module notifies the forwarding layer to delete the information of the user contained in the user service QoS configuration library.

If a user initiates an attack, the user bandwidth limitation and priority remark module may identify and discard the attack packet(s) of the attacking user, so that the bandwidth of other normal users may not by preempted, and accordingly the call of the other users may not be influenced. Even if the system is attacked, the quality of calls may be guaranteed for the users that have registered successfully.

According to some embodiments of the invention, a signaling sorting method is employed, to analyze signaling packets by which various soft terminals/hardware terminals register to a system and call the system, as well as the resource reservation signaling packets delivered from the policy server, etc., extract the user information, such as the telephone number or domain name of the user and the audio, video and data information, from the signaling packet, and analyze whether the system has been configured with the QoS information corresponding the signaling feature codes, and if the matched configuration information of the user is found, perform bandwidth limitation and bandwidth guarantee according to the QoS information. In this way, the bandwidth of various users will not interfere with each other, different types of services, such as audio, video and data, may be guaranteed with different bandwidth and different DSCP priority remarks. Therefore, the intelligent control for user traffic may be achieved.

What is claimed is:

1. A method for providing Quality of Service, QoS, service, comprising:
constructing user service QoS configuration information at a forwarding layer according to signaling feature codes of the signaling packet when receiving a signaling packet of a user or a resource reservation signaling packet delivered by a policy server, and
querying, when receiving a service packet of the user, the user service QoS configuration information according to service information of the service packet; performing bandwidth guarantee for the service packet according to a query result.

2. The method according to claim 1, wherein, said constructing the user service QoS configuration information comprises storing user information, service type information and QoS information corresponding to service types of users in a user service QoS configuration library.

3. The method according to claim 2, wherein, the QoS information comprises bandwidth, time delay and priority remark Differentiated Service Code Pointer, DSCP, value, and is configured by a network management station, control station or policy server.

4. The method according to claim 1, wherein, said constructing the user service QoS configuration information at the forwarding layer according to the signaling feature codes of the signaling packet comprises:
identifying, by the forwarding layer, the signaling packet to be processed, and sending the signaling packet to a control layer;
extracting the signaling feature codes of the signaling packet by the control layer; and
matching QoS information corresponding to the signaling feature codes, and delivering user information obtained from the matching and QoS information of corresponding service type to the forwarding layer.

5. The method according to claim 4, wherein, the signaling feature codes comprise a user identification and service type identifications.

6. The method according to claim 2, wherein, said querying the user service QoS configuration information comprises:
identifying, by the forwarding layer, service type of the service packet, and querying QoS information corresponding to the service type according to the service type of the service packet; and
said performing bandwidth guarantee for the service packet according to the query result comprises:
performing bandwidth limitation and priority Differentiated Service Code Pointer, DSCP, remark according to the QoS information corresponding to the service type contained in the user service QoS configuration information.

7. The method according to claim 6, wherein, said performing bandwidth guarantee for the service packet according to the query result further comprises: inserting the service packet into a corresponding priority queue according to the priority DSCP remark, performing queue scheduling according to priorities, and forwarding the service packet.

8. The method according to claim 1, further comprising: deleting, by a control layer, information of the user in the forwarding layer, when receiving a call termination signaling packet from the user.

9. The method according to claim 1, further comprising: discarding, by the forwarding layer, an attack packet from a user, and preventing the user to preempt bandwidth of other normal users.

10. A system for providing Quality of Service, QoS, service, divided into a control layer and a forwarding layer, comprising:
a user media and QoS information management module, located at the control layer, adapted for searching for QoS information matched with signaling feature codes of a signaling packet of a user, and constructing user service QoS configuration information at the forwarding layer according to the signaling feature codes;
a user bandwidth limitation and priority remark module, located at the forwarding layer, adapted for querying the user service QoS configuration information according to service information of a service packet of the user, and processing the service packet according to a querying result; and
a user bandwidth guarantee module, located at the forwarding layer, adapted for perform bandwidth guarantee according to the processing by the user bandwidth limitation and priority remark module to the service packet.

11. The system according to claim 10, further comprising a user media packet classification processing module adapted for identifying service information of the service packet and transmitting the service information to the user bandwidth limitation and priority remark module; the service information comprising service type.

12. The system according to claim 11, wherein, the user bandwidth limitation and priority remark module comprises:
a bandwidth limitation module adapted for limiting bandwidth according to QoS information corresponding to the service type contained in user service Qos configuration information; and
a priority DSCP remark module adapted for performing priority DSCP remark according to the QoS information corresponding to the service type contained in the user service Qos configuration information.

13. The system according to claim 12, wherein, the user bandwidth guarantee module comprises a plurality of queues with different priorities adapted for accommodating service packets with different priority remarks and a queue scheduling module adapted for performing queue scheduling according to the priorities.

14. The system according to claim 10, further comprising:
a user service QoS configuration library, located at the forwarding layer, adapted for user information, service type information and QoS information corresponding to various service types of users according to the constructed user service QoS configuration information.

15. The system according to claim 10, further comprising:
a network management station, control station or policy server, adapted for configuring the signaling feature codes, QoS parameters corresponding to different signaling feature codes and a corresponding DSCP value; and
a feature code QoS configuration library, adapted for storing information configured by the network management station, control station or policy server so as to be queried by the user media and QoS information management module.

16. The system according to claim 10, further comprising:
a signaling sorting processing module, located at the forwarding layer, adapted for sorting service packets from user terminals, and sending the sorted service packets to the control layer; and
a signaling analysis processing module and a signaling feature code extraction module, located at the control layer, adapted for analyzing the service packets forwarding from the forwarding layer, obtaining signaling feature codes of the service packets and sending the signaling feature codes to the user media and QoS information management module.
